(19) United States
(12) Patent Application Publication
(10) Pub. No.: US 2016/0292756 A1
(43) Pub. Date: Oct. 6, 2016

(54) PROCESS AND SYSTEM FOR PROVIDING A FIXED UTILITY BILL

(71) Applicant: JUAN MARCH VILLAR, ORFORD, NH (US)

(72) Inventor: JUAN MARCH VILLAR, ORFORD, NH (US)

(21) Appl. No.: 14/677,837

(22) Filed: Apr. 2, 2015

(51) Int. Cl. G06Q 30/04; G06Q 50/06

(52) U.S. Cl. CPC G06Q 30/04; G06Q 50/06

(57) ABSTRACT

Disclosed is a method of providing a fixed utility bill for a billing period to a utility consumer of a utility product including the steps of maintaining in a rolling historical database, for each utility consumer, environmental indicator, consumption, and optional pricing data, which is used for calculating a continuous probability distributed current expectation value of a quantity of consumption for the utility consumer, calculating a risk position in the form of a current fixed bill based upon the current expectation value, and matching the risk position with a balancing fixed payment to a utility distribution company. Also disclosed is a system architecture for providing the fixed billing process that includes a computer in communication with a rolling historical database. The computer continually monitors the consumption behavior of the utility consumers and current environmental indicators to update the database.

### BACKGROUND OF THE DISCLOSURE

1. Field of the Disclosure

The disclosure herein relates to methods for managing the consumption risk costs of a utility sold at a fixed price and, more particularly, methods for managing the weather-related risks associated with energy pricing.

2. Description of the Related Art

Energy utility consumers nationwide suffer substantial cost risk from month-to-month and year-to-year. As an illustration, the NYMEX contract for natural gas has been the most volatile contract ever traded with near-term volatilities regularly exceeding 40 to 70%, well above that for all other commodities traded. For budget-sensitive utility consumers, actual expenditures for energy can easily be 20% or more above or below what was budgeted.

There are two key sources for the energy cost risk facing these utility consumers: price risk and consumption risk. In natural gas, price risk is evidenced in the volatilities of the NYMEX contract and other over-the-counter location-specific instruments (swaps, basis swaps, forwards). In electricity, the new NYMEX electricity contract is showing at least as much volatility as natural gas.

There are, however, a number of price risk management tools available, especially in the energy markets, such as fixed forward contracts and commodities derivatives. Consumption risk, on the other hand, is not well managed in energy markets. Accordingly, there is a need for a fixed bill product to manage total energy cost risk including the consumption risk.

### BRIEF SUMMARY OF THE DISCLOSURE

Disclosed is a method of providing a fixed utility bill for a billing period to a utility consumer of a utility product including the steps of maintaining in a rolling historical database, for each utility consumer, environmental indicator data and associated consumption of the utility product data, calculating a continuous probability distributed current expectation value of a quantity of consumption for the utility consumer, calculating a risk position in the form of a current fixed bill based upon the current expectation value, and matching the risk position with a balancing fixed payment to a utility distribution company.

Also disclosed is a turnkey provider process to provide a utility provider with the ability to provide fixed utility bills to utility consumers of a utility product, comprising the steps of receiving from the utility provider a list of participating utility consumers, maintaining in a rolling historical database, for each utility consumer, environmental indicator data and associated consumption of the utility product data, calculating a continuous probability distributed current expectation value of a quantity of consumption for each the utility consumer, calculating a risk position in the form of a current fixed bill based upon the current expectation value for each the utility consumer, and receiving payments on the fixed bills from each the utility consumers, matching the risk position with a balancing fixed retained fee from each the received payment and retained proceeds from environmental indicator hedge positions, and distributing the remainder of each the payments and proceeds from environmental hedge positions to the utility distribution company as a fixed payment amount.

Also disclosed is a system architecture for providing fixed billing process that includes a computer, a rolling historical database in communication with the computer, the database configured to receive and hold historical and current consumption, billing, and weather indicator data on a rolling basis over the past Y years for at least one utility consumer, the computer programmed to (a) receive current weather indicator data, (b) issue fixed utility bills to each the utility consumer, (c) monitor each the consumer's consumption of a utility product and adjust current billing, as needed, of the utility consumer with a surcharge or credit upon the consumer's consumption falling outside a pre-calculated bandwidth, and (d) write the current consumption, current billing, and current weather indicator data to the rolling historical database.

### BRIEF DESCRIPTION OF THE DRAWINGS

FIG. 1 is a flow diagram of a main process of the disclosure.

FIG. 2 is a flow diagram of the processes included within module 120 of FIG. 1.

FIG. 3 is a flow diagram of the processes included within module 130 of FIG. 1.

FIG. 4 is a flow diagram of the processes included within modules 150 and 170 of FIG. 1.

FIG. 5 is an illustrative table of actual weather indicators for a particular location.

FIG. 6 shows tables of yearly weather indicator values for a particular month at a particular location over 30 years and a graph derived from those values.

FIG. 7 is a diagrammatic view of an overall system architecture for executing the processes of the disclosure.

### DETAILED DESCRIPTION OF THE DISCLOSURE

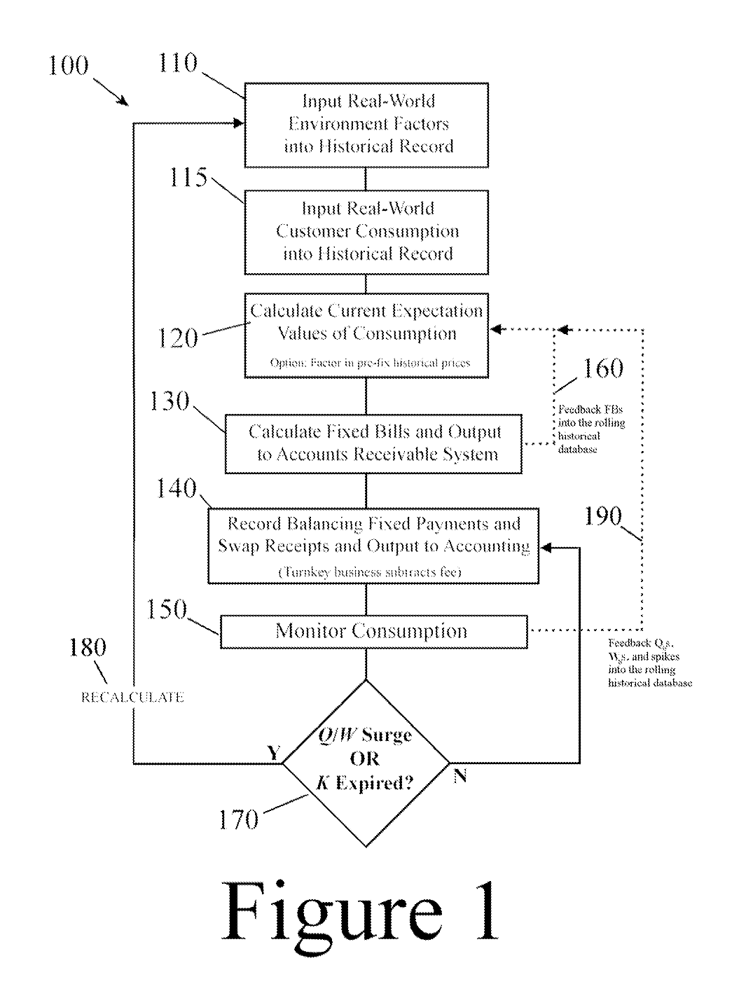

Referring to FIG. 1, there is shown a main process 100 of the disclosure for producing and providing a fixed bill to a utility consumer for a utility product, which may be executed by way of software or hardware modules on a computer system. The process begins at module 110 wherein real-world environmental factors that affect the price of the utility product provided over some period are read into a database in machine-readable form so as to establish a machine-readable historical records for the purposes of performing the calculations set forth below. For utilities providing energy, such as gas, oil, or electric, weather data is a primary environmental factor and will be used to illustrate the disclosure herein.

At module 115, historical real-world data including consumption of the utility product by a particular utility consumer corresponding to the period covered by the historical environmental record.

Moving on to module 120, the historical environmental and consumption data is enough to begin the process of calculating current expectation values for the utility consumer's consumption. As an option, more precise expectation values may be calculated if one factors in the utility consumer's historical billing records as will be explained more fully below. For now, we describe the simple weather/consumption model where cold weather stimulates demand for heating energy and hot weather stimulates demand for cooling energy.

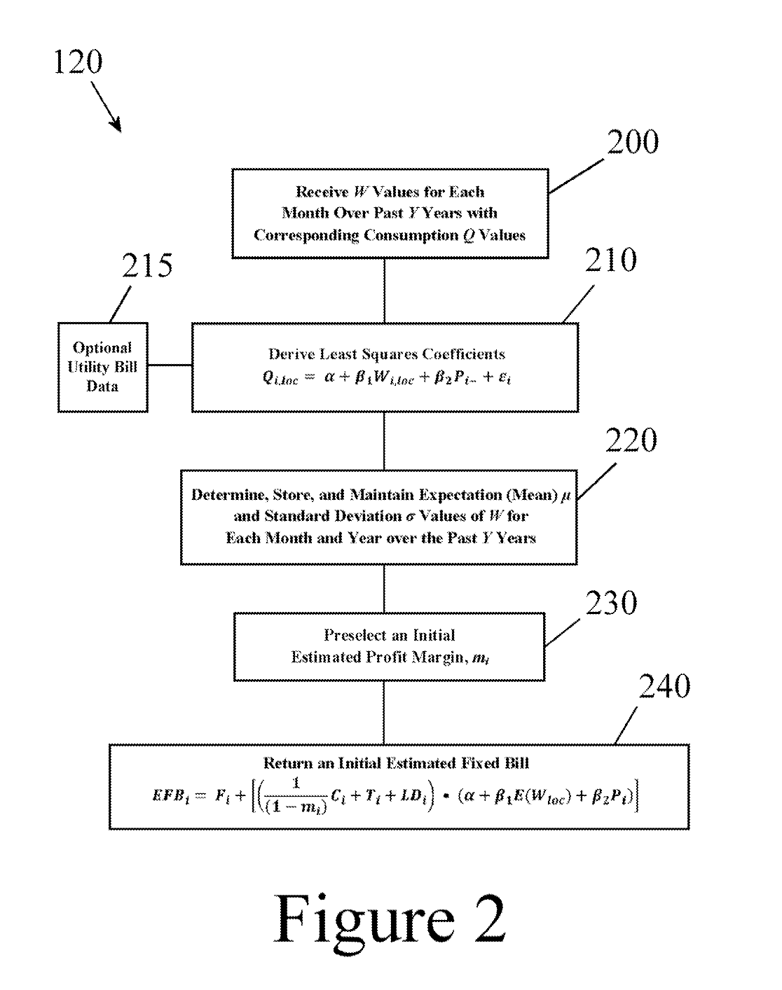

Referring to FIG. 2, there are shown processes included within module 120 of FIG. 1. A utility consumer's typical utility bill UB for a given consumption period i (of Dᵢ days) can be shown as in Equation (1) below:

$${UB}_{i} = {F}_{i} + ( \frac{1}{( 1 - {m}_{i} )} {C}_{i} + {T}_{i} + {LD}_{i} ) \cdot {Q}_{i} \qquad ( 1 )$$

wherein,
Fᵢ=fixed costs per unit for the commodity consumed in consumption period i,
Cᵢ=variable commodity costs per unit for the commodity consumed in consumption period i,
mᵢ=the utility provider's gross margin per unit on the costs Cᵢ of the commodity, exclusive of fixed F, transportation T and local delivery LD costs, where 0≦mᵢ≦1.00
Tᵢ=the variable long distance transportation costs per unit for the commodity consumed in consumption period i,
LDᵢ=the variable local delivery costs per unit for the commodity consumed in consumption period i, and
Qᵢ=the quantity of the commodity consumed in consumption period i.

In Equation (1), the utility consumer could easily fix a portion of the costs by using futures or over-the-counter instruments to lock in a price on the portion of consumption that is known with certainty. For instance, any energy consumption that is not weather driven may be highly predictable. A utility consumer could then fix the cost of this portion of total consumption with confidence that an effective hedge is achieved. To the extent, however, that the consumption is weather driven, the utility consumer cannot confidently lock in a price.

An industrial utility consumer with baseload (fixed fuel quantity) process requirements can achieve all the hedge required by simply locking in prices. A school district or hospital with significant unknown weather-driven requirements cannot reduce risk with the same hedge; a large portion of its risk is tied up in the weather risk as opposed to the price risk. For these reasons, one can think of the consumption variable Qᵢ as in Equation (2).

Q_{i,loc}=f(Bᵢ,W_{i,loc}) (2)

wherein,

Bᵢ=base (predictable) consumption in consumption period i, and
W_{i,loc}=a location-specific weather indicator.

Suitable weather indicators as a measure of weather conditions are those used by the Chicago Mercantile Exchange (CME), namely either HDD_{i,loc} for heating degree-days during the i^{th} period at location loc, or CDD_{i,loc} for cooling degree-days for the i^{th} period at location loc. These are derived by, for any single given day within the consumption period i, taking 65 degrees (Fahrenheit) less the average daily temperature at a given location to find the number of heating degree-days (HDD_{loc}≡65−T̅_{loc}) for that day, and taking the average daily temperature at the same location less 65 F.° to find the number of cooling degree-days (CDD_{loc}≡T̅_{loc}−65) for that day. Also traded on the markets are futures and derivatives based on growing degree-days (GDD_{loc}≡T̅_{loc}−50). All three weather indicators are defined only for non-negative values (i.e., all negative results are set=0). Of course, the user of this disclosure is free to create his own weather indicator and forgo the convenience of using an industry standard, but the convenience of the established weather indicators is that futures and options markets already exist for them.

A 1-day W (where W is HDD, CDD, GDD, or user-defined) is the basic unit of the weather derivatives industry in the United States. To calculate the W for the one or more days that make up a consumption period i, one adds together all of the seven W values for each day of the week. One does not take the average temperature over the seven days and subtract from 65 or subtract 65 therefrom. For example, if the HDD values for three days in a row were 15, 20, and 25, then the HDD value for the entire three-day period is 15+20+25=60. It is done this way because we are interested in a measure of total heating cost, not average heating cost.

For commodities like water and electricity which can be monitored by “smart meters,” the consumption period may be arbitrarily defined as a month to correspond with a monthly billing period. For commodities like heating oil and gas, the consumption periods may vary widely where delivery is made by truck, depending on the tank capacity of the consumer. Accounting software will be configured to attribute consumption to the time period covered to calculate a monthly bill. In doing these calculations we may, over the course of a month, record the CDD and HDD values incrementing every day until the new month begins and the count starts at zero again. This will render monthly W values by the same convention that the CME uses for the purposes of this disclosure, though the user is of course free to use his own. The gives us the following equations for any consumption period i of Dᵢ total days of the heating or cooling seasons:

W_{i,loc}=HDD_{i,loc}=Σ_{d=1}^{D}^{ᵢ}(65−T̅_{i,loc}), if <0 [symbol] 0 (3a)

W_{i,loc}=CDD_{i,loc}=Σ_{d=1}^{D}^{ᵢ}(T̅_{i,loc}−65), if <0 [symbol] 0 (3b)

where Dᵢ is the total number of days in month i when we operate on a monthly scheme, allowing us to provide a varying, but fixed bill for every month over the course of the heating or cooling season, meaning that the bill each month may vary, but the bill will be known in advance. Alternatively, we can set Dᵢ equal to the number of days in the whole heating or cooling season—or the whole year for that matter—and divide by the number of months to derive a monthly bill that is unchanged month-to-month.

Regardless, it will be desirable to keep a monthly record of W values for the purposes of creating and maintaining a historical record for the purposes of processing the equations described below via the reception of these W values at module 200 in FIG. 2 and for deciding what contracts to buy to create strips of options on the weather exchanges as will be described more fully below.

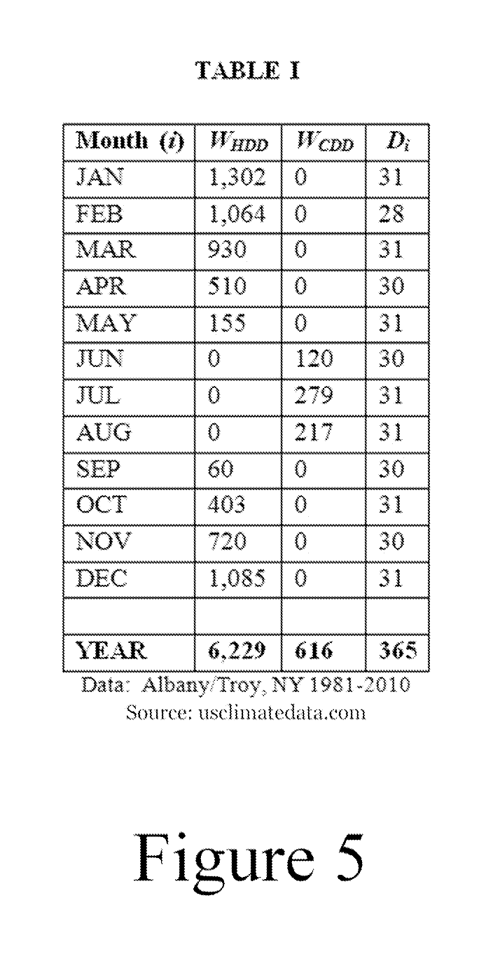

For example, in FIG. 5 there is shown a chart of mean HDD and CDD values for the Albany/Troy area of upstate New York, averaged over the thirty years from 1981 to 2010. Notice that because the W values for each month are cumulative sums, the yearly W value is simply obtained by adding the twelve monthly values. Also, because HDD=−CDD prior to zeroing the negative values, one may be derived from the other without having to repeat the summing process. If we also have records of what quantity Q of the utility commodity was consumed, we could create and maintain a matrix of the rate of consumption per degree-day=Qᵢ/W_{i,loc} for each location loc and consumption period i.

Note also the difference between the values for January and February, 1,302 and 1,064, respectively, representing a 22% difference. This despite the fact that the mean temperatures are 25° F. and 28° F., respectively (source: weather.com), representing only an 11% difference. The discrepancy derives from the differing number of days in each month. Hence, for January the value of Dᵢ=31 in Equations (3a) and (3b), while that for February is usually Dᵢ=28, as in the example shown.

For a given utility consumer, Equation (2) can be estimated with ordinary regression analysis in a model of the form:

Q_{i,loc}=α+βW_{i,loc}+εᵢ (4′)

Closeness of fit is normally the objective in estimating Equation (4′), so the results of Equation (4′) can be variously estimated with non-log, semi-log, or log-log forms. Of course, to use this equation we need to get a hold of the consumption data for the utility consumers. That may require making a deal with a new utility consumer's prior utility. We can get an even more accurate fit if we can read in the utility billing history 215 of the utility consumer. This may raise some privacy issues, but a waiver could be obtained from the utility consumer. The historical data for a particular utility consumer allows for an even more accurate least squares analysis of consumption:

Q_{i,loc}=α+βW_{i,loc}+β₂P_{i-,loc}+εᵢ (4)

as shown in module 210 where P_{i-,loc} is the historical price per unit commodity from the immediately preceding consumption period i− for the same location loc. This is on the theory that utility consumers adjust their consumption in response to the bill for the immediately preceding billing period i−. Separating out and rearranging this component reveals a classic demand curve

$${P}_{i - , loc} = \frac{1}{{β}_{2}} {Q}_{i , loc} + α ,$$

where β₂<0. For a commodity of inelastic demand such as heating oil, we may expect β₂ to be small in comparison with more elastic commodities. This may not be the case in situations, for example, where the utility consumer knows in advance what the fuel cost will be, in which case the current bill for the immediate consumption period P_{i,loc} may be used. Notice that the price for period i is given by

$${P}_{i} = {F}_{i} + ( \frac{1}{( 1 - {m}_{i} )} {C}_{i} + {T}_{i} + {LD}_{i} ) \qquad ( 5 )$$

If however the billing information is not available for a particular utility consumer, then the coefficient β₃ is simply set to zero and the computations proceed as in Equation (4′).

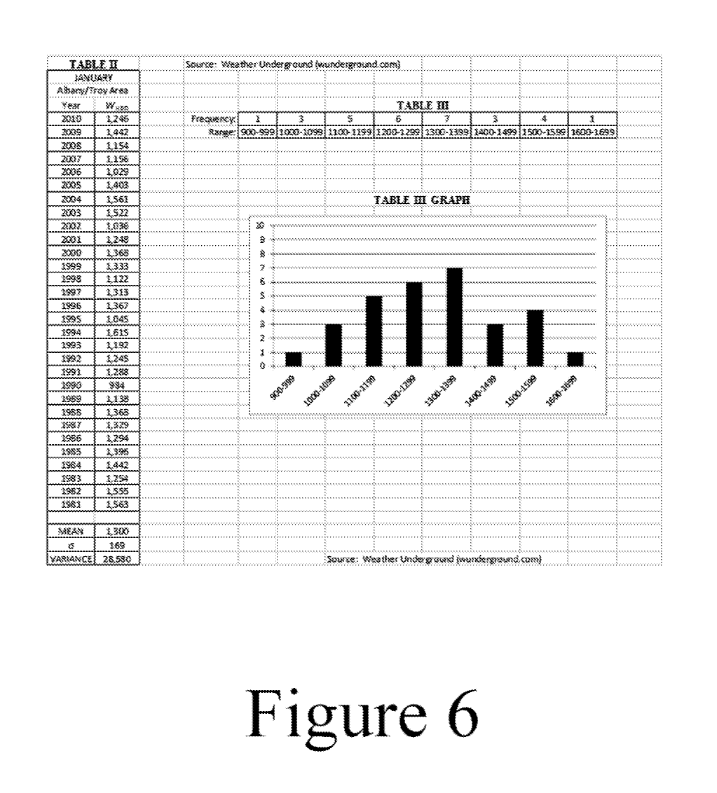

Next, we may make an assumption that W_{i,loc}˜N(μ,σ), that is, that the continuous probability distribution that describes the location-specific weather indicator W is normally distributed with mean μ and standard deviation σ. We can construct such a distribution curve for each month by plotting out W values. In FIG. 6 are shown Tables II and III, for example, holding spreadsheet data used to generate a distribution plotted out for the month of January in the Albany/Troy area over the same time period (1981-2010) covered by Table I from FIG. 5. The basic shape of a bell curve is apparent in FIG. 6 in the Table III Graph.

From this data a random number generator subroutine can be set up to generate an HDD or CDD value for use in Monte Carlo simulations, the use of which is described below. For example, one could program a subroutine to first randomly select a range, the probability of which is determined by the observed frequency (e.g., probability of 1200−1299=6/30), and then randomly select an integer within the range.

Alternatively, one can use the calculated mean and standard deviation to define an equation for a normal curve, which can then be used by the random number generator subroutine to generate W values by any one of known methods, such as the Box-Muller method, the Marsaglia polar method, and the Marsaglia-Tsang ziggurat algorithm, to name a few.

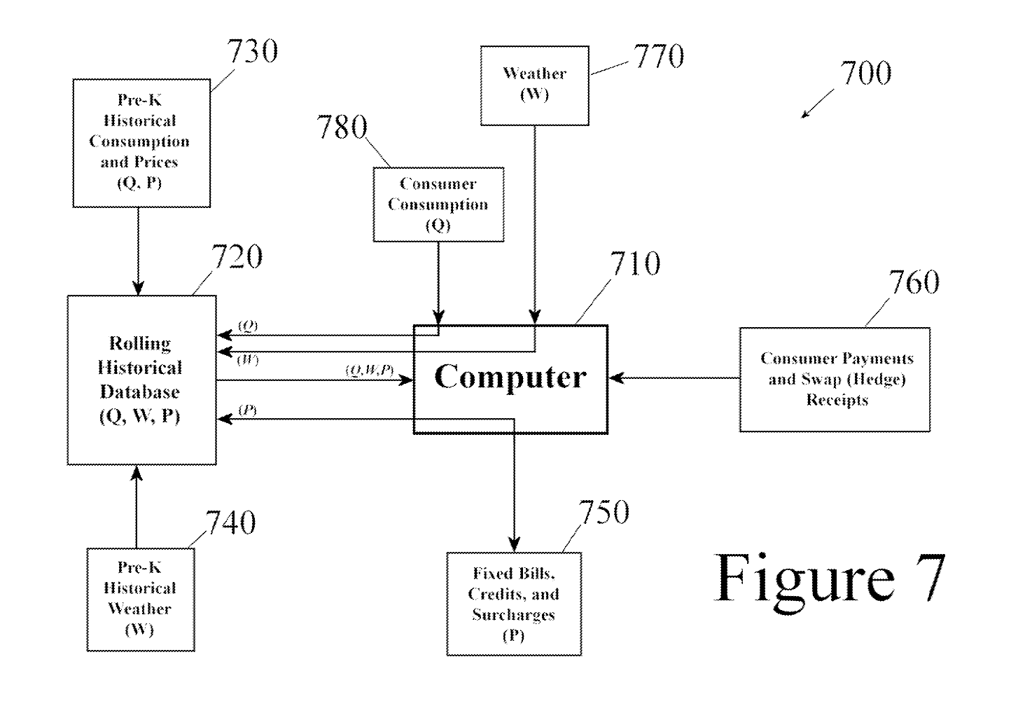

How many years Y back one wants to go is somewhat arbitrary, but not entirely. We would want to go back far enough to have a statistically significant number of samples, yet we also do not wish to go so far back that we lose information about any possible drifting of the local climate. Generally, one may expect to be sampling from about ten to thirty years in the past. Note for example that if we sample Y=20 years (1991-2010), we would obtain a mean HDD of μ=1,284 with σ=167, reflecting a drift to lower temperatures (Note, Y=10 yields μ=1,280, σ=183). Because we are going back only a finite number of years from the present, our historical record can be said to be a running historical record, stored in a rolling historical database 720 (see FIG. 7).

We can then create an broad view of a utility consumer's consumption pattern at module 220 by calculating the mean values p and standard deviations σ of weather indicators (W) for each month over the past Y years and also the mean values for each of the last Y fiscal years. This is more information need to calculate a fixed bill, but, as will be described in more detail below, will be useful in determining the fixed bill arrangement needs to be adjusted in response to a fundamental shift in a particular utility consumer's consumption pattern.

With the assembling of the various estimations and identities, an initial estimated fixed bill (EFB) for a utility consumer is derived by first choosing a desired initial gross margin mᵢ from management at module 230 and then using that value to return an initial estimated fixed bill at module 240 from the equation:

$${EFB}_{i} = {F}_{i} + [ ( \frac{1}{( 1 - {m}_{i} )} {C}_{i} + {T}_{i} + {LD}_{i} ) \cdot ( α + {β}_{1} E ( {W}_{loc} ) + {β}_{2} {P}_{i} ) ] \qquad ( 6 )$$

which might also be written as:

$${EFB}_{i} = {F}_{i} + [ ( \frac{1}{( 1 - {m}_{i} )} {C}_{i} + {T}_{i} + {LD}_{i} ) \cdot E ( {Q}_{loc} ) ] \qquad ( 6 b )$$

As Equations (6) and (6b) show, the usage level, once estimated for a given utility consumer in a given location, is now fixed as an expectation value E(Q_{loc})=(α+β₁E(W_{loc})+β₂Pᵢ) for purposes of defining the consumption Q for the consumption period i. Notice we no longer use the price Pᵢ₋ from the previous consumption period i− because the consumer knows what the price will be under the fixed bill system, ergo Pᵢ for the effect of price on quantity of consumption Q_{loc}. If i is monthly, you have estimated bills for each month of the heating or cooling season (or the whole year, for that matter). You can use this as the basis to charge the utility consumer a pre-fixed, though varying amount month-to-month, or add them up and divide by the number of months to provide a steady unchanging utility bill throughout the heating or cooling season or throughout the entire year. First, though, it is necessary to adjust this estimated bill into a final bill by adjusting the gross margin mᵢ to a value Mᵢ determining a price FBᵢ(Mᵢ) that a utility consumer is willing to pay and a utility provider is willing to accept over a particular consumption period i. This fixed rate represents the risk position of the utility consumer which will then be balanced with a counter-risk position for the utility provider.

The model presented above identifies a conceptual approach to understanding how a fixed bill transaction might be calculated for a utility consumer. In practice, this concept is only a starting point. A provider of fixed bill transactions will be much like a provider of other risk management tools in that the risk that is extracted from utility consumers must be laid off with counterparties that have an opposite appetite for the risk. All risk management markets are made up of parties with appetites for length positions and parties with balancing appetites for short positions. Thus, the utility provider will have the goal of matching “shorts” (sales to utility consumers) with length while maintaining a margin between these positions.

A natural counterparty for the energy transaction discussed above would be a reasonably co-located distribution company that has the opposite economic appetite for weather patterns. Where utility consumers are concerned about colder than normal winters, distribution companies are concerned about warmer than normal winters. The opposite risk positions make a risk management trade possible. The utility provider's goal then is to find a distribution company that is willing to pay an amount of money when the winter is colder than normal (and the company is making more money from sales to afford it) in return for income to the utility when the winter is warmer than normal. This is a swap, which would be the equivalent of a futures contract(s) were it executed on the commodities market. In fact, if no reasonably located distribution company is available, one may establish the counter-position by purchasing a strip of weather derivatives (e.g., futures, options) on an exchange.

It may be rather difficult, especially for a large utility, to find someone will to swap. If a utility is large enough, it usually is the distribution company. As an alternative then, the utility has the ability to trade in futures and derivatives thereof on the various commodities exchanges that offer futures priced on W points.

The fear of the energy utility when offering fixed billing is the opposite of its usual concern. Normally a utility fears warm weather, resulting in unsold energy and storage costs. On a fixed bill system, the fear is now unexpectedly cold weather imposing an obligation to provide more energy without any increase in revenue. Hence, if the utility cannot factor this into the gross margin Mᵢ, the utility may resort to a strip of options or futures covering the months of the heating season. Options are often desirable because they offer greater leverage than a future. Typically, someone desiring to hedge on the market would purchase a strip of contracts to cover the heating or cooling season, meaning that if, for example the heating season ran from October to April, the utility would buy long on HDD contracts for every month from October to April. If the cooling season is from June to August, then the utility would go long on CDD contracts. Strips of contracts over the length of the heating or cooling season are a desirable alternative to a single contract covering the whole season because the utility can always “bail out” mid-season by selling off the unexpired monthly contracts if it turns out the utilities cold weather fears are not to be realized.

At the simplest level, once Equation (6) is approximated for a given utility consumer one can divide the variable cost portion

$$( \frac{1}{( 1 - {m}_{i} )} {C}_{i} + {T}_{i} + {LD}_{i} )$$

of the calculated Estimated Fixed Bill (EFBᵢ) by the expectation values E(HDD) or E(CDD) calculated at module 220 of FIG. 2 to obtain the provider's marginal cost per HDD or CDD. Given this, the provider would search for a distribution company interested in a swap, or a strip of weather derivatives, that satisfies the following condition:

$$\frac{\partial Costs}{\partial τ {DD}_{loc}} \leq \frac{\partial Swap Income}{\partial τ DDloc} \qquad ( 7 )$$

Equation (7) simply says that when a provider's costs increase with actual heating degree-days (marginal weather-driven costs) at the loc^{th} location he would want (at least) precisely offsetting swap income to cover that marginal weather-driven cost. Notice that if the utility chooses to trade in weather futures instead of options, its Swap Income per W is fixed at $20 per degree-day as the cash settlement value of a weather contract under the rules of the Chicago Mercantile Exchange, which may or may not be enough. Hence, options are the most commonly used weather derivative to overcome this limitation. Such options are typically contracted for Swap Income per W set in the thousands of dollars.

Laying off risk for a fixed bill transaction, however, is quite different than it is for most risk management products. This results because (a) weather is not a fungible commodity, and (b) the counterparties will often desire risk protection at different, imperfectly correlated weather locations. Contrasted with a situation like an Exchange contract where a provider could establish equal and exactly offsetting positions, the provider retains some unhedgeable weather risk when short positions are established at one location and long positions are established at different locations and it is a feature of large utilities that the utility consumers are usually scattered about in differing microclimates. The best the provider can do is build a book around reasonably correlated weather patterns.

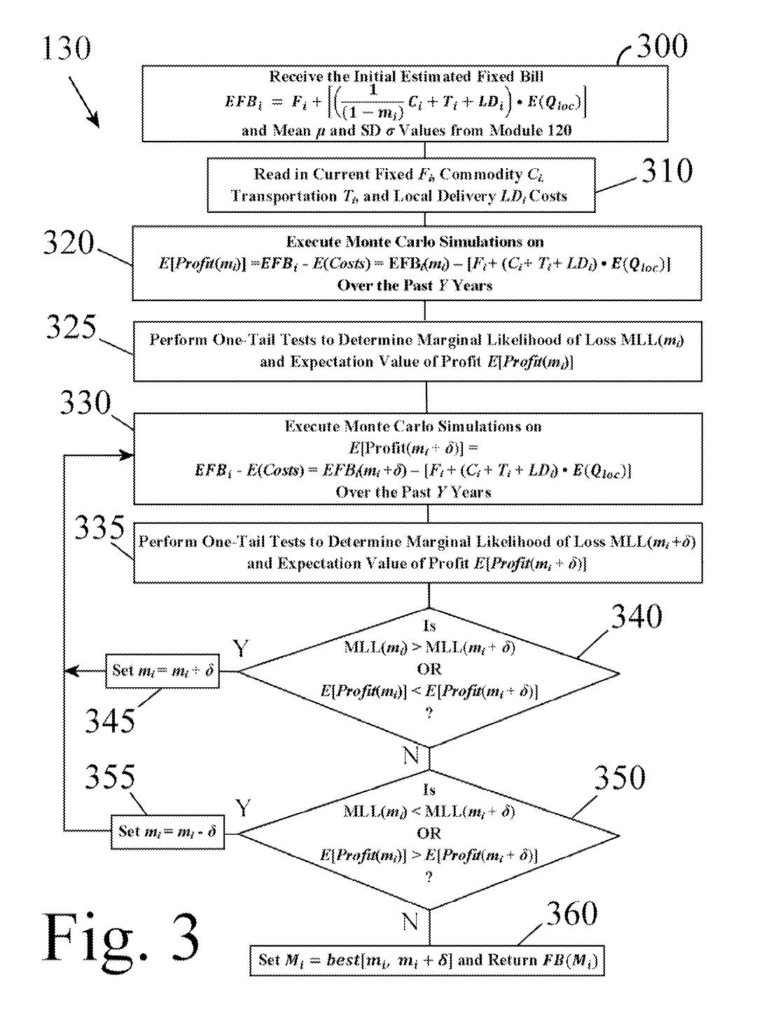

In theory, one could evaluate the economically weighted joint probability density function W_{i,loc}˜N(μ,σ) parametrically for all locations in the provider's book. However, this proves quickly intractable as the number of locations loc increases to approximately three. Rather, the steps taken in pricing a deal, and in managing the portfolio, may involve the following steps within module 130 of FIG. 1, which is shown in detail in FIG. 3.

Referring then to FIG. 3, there are shown processes of module 130 from FIG. 1, wherein the estimated fixed bill EFBᵢ returned by module 120 is received at module 300 along with mean μ and standard deviation σ values (if already calculated, otherwise they may be calculated here). The following procedure is then executed:
1. At module 310 evaluate the usage and all costs for a prospective deal;
2. At module 320 perform a Monte Carlo simulation across all deals at all locations in the book over the last Y=about 10 to about 30 years of weather patterns and establish the payoffs from each deal under each historical weather pattern. Because the weather patterns are themselves normally distributed, the profits EFBᵢ−E(Costs) may be assumed to also be distributed N(μ,σ);
3. At module 325 perform one-tail tests to determine the marginal likelihood of suffering a loss on the deal and the expectation value of profit E[Profit(mᵢ)] using the desired initial gross margin mᵢ included in the initial evaluation of Equation (6) from module 120;
4. At modules 330 and 335, repeat steps 2 and 3 using an incremented value of mᵢ, namely mᵢ+δ, where the delta δ is selected by the user and will generally be a fraction of mᵢ.
5. At module 340, determine if the results at module 335 show a reduced marginal likelihood of loss MLL(mᵢ+δ) as compared to the MLL(mᵢ) result of module 325, or an increased expectation value of profit E[Profit(mᵢ+δ)] over that of module 325 (indicating price is too low). If so, set mᵢ=(mᵢ+δ) and go back to step 4 (modules 330, 335). Otherwise, proceed to step 6.
6. At module 350, determine if the results at module 335 show an increased marginal likelihood of loss MLL(mᵢ+δ) as compared to the MLL(mᵢ) result of module 325, or an reduced expectation value of profit E[Profit(mᵢ+δ)] over that of module 325 (indicating the price is too high). If so, set δ=−δ and mᵢ=(mᵢ+δ) and go back to step 4 (modules 330, 335). Otherwise, proceed to step 7.
7. If neither the conditions of steps 5 and 6 are met, then losses MLL and profits E(Profit) are equal or approximately equal over the incremental change mᵢ+δ. Select the gross margin mᵢ or (mᵢ+δ) that produced the best profit and loss results, set that equal to Mᵢ, and return the optimal fixed bill FB(Mᵢ). at node 360.

Returning our attention to FIG. 1, note that the fixed bill FB(Mᵢ) returned by module 130 is itself a price P that becomes part of the historical record that is fed back 160 to module 120 for future calculations.

At module 130, the fixed bill is forwarded to whatever Accounts Receivable system the user is utilizing, which will likely be a pre-existing accounting software system. Accounts receivable bills the customer and perhaps automatically charges the energy customer's bank account. The Accounts Receivable may be configured to bill automatically without further input from the main processing system until the contract K has concluded or a surge detected (as explained below) and control returned to module 110.

At module 140 payments received from customers and payoff from swap receipts (hedge positions) are recorded and outputted to accounting for posting. In the case of turnkey providers that handle the fixed billing system for a utility provider who would rather pay a company to run the operation rather than do it themselves, a balancing fixed fee will be extracted from the energy consumer's payment and any payoffs from hedge positions and the remainder of such payments outputted to Accounts Payable for payment to the utility provider. Whether turnkey or not, the utility provider's payoff will generally be a the sum of the utility consumer's fixed payments and swap receipts from derivatives traded on the exchanges.

With the fixed bill calculated as described for a utility consumer, several risks remain for the provider of such service:
1. Consumption Spike. How does the provider allow for the fact that the utility consumer may be encouraged to become less efficient in its utilization of energy now that it can consume all it wants for a fixed payment?
2. Consumption Surge. How does the provider allow for structural long term changes in the utility consumer's energy consumption (e.g., a residential utility consumer adds a new wing to the house, an industrial utility consumer expands plant and equipment).
3. Non-Weather Price Volatility. How does the provider allow for price volatility, apart from the weather volatility?

### Consumption Spike

A key feature of the final utility consumer agreement is that energy use per HDD or CDD remains within a band established as the annual standard error εᵢ of the intercept in the usage estimation of Equation (4). This is typically a band with a width of 2% or so. In the event the utility consumer consumes more than εᵢ more commodity per degree-day than shown historically, then it is charged the excess quantity Qₓ consumed at the going market price Pᵢ.

In practice, one would monitor the utility consumer's use on a regular basis, such as monthly, as indicated at module 150 in FIG. 1. This might be done by checking electric meters, electronic monitoring of “smart meters,” prorating heating oil and gas deliveries, or electronic wireless meters fitted to heating oil and propane tanks, readable through an internet connection or other means.

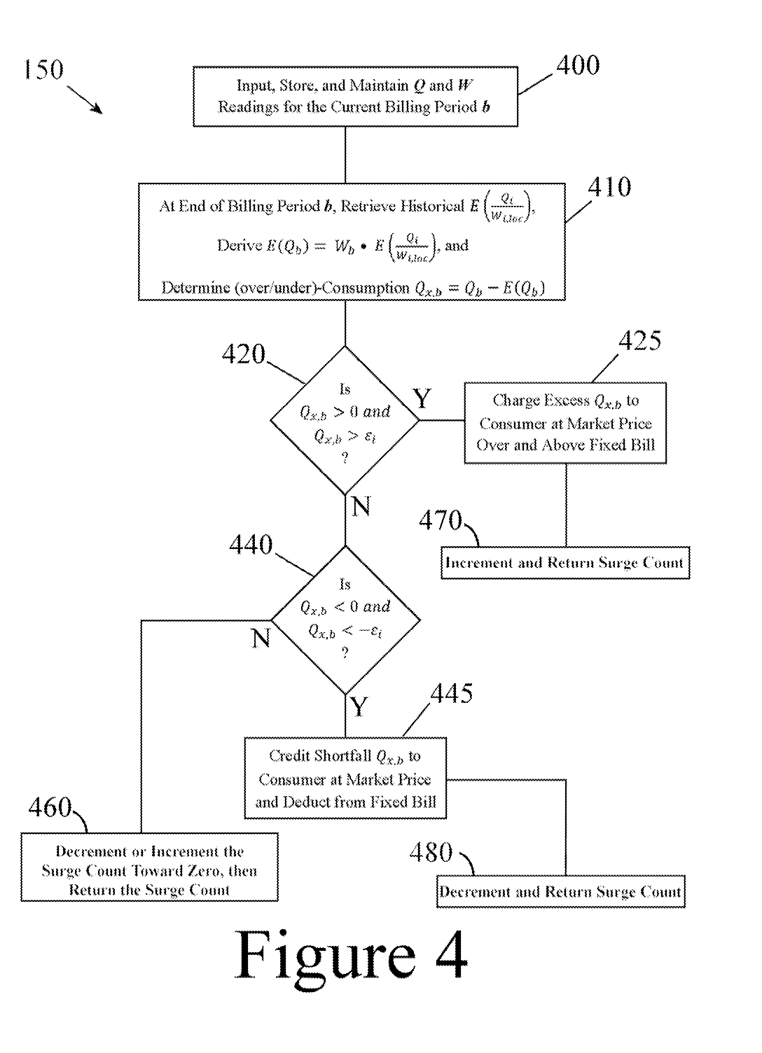

Referring to FIG. 4, the utility consumer's monitored data is read in as consumption Q readings while weather indicators W are read in in the usual manner—either from published data for the location or from instrumentation—at module 400.

When the billing period b ends, Q_{b} and W_{b,loc} are then known and module 410 retrieves the historical expected consumption per unit weather indicator data for the billing period. This is from a database created and maintained by the fixed bill system of the disclosure in a manner analogous to the weather data created by Equations (3a) and (3b), excepting that the summations that make up the raw data for this database, which we call the Q/W database are as follows:

$$\begin{matrix}\frac{{Q}_{i}}{{W}_{i , loc}} = \frac{{Q}_{i}}{{HDD}_{i , loc}} = \frac{{Q}_{i}}{{\sum }_{d = 1}^{{D}_{i}} ( 65 - {\overline{T}}_{i , loc} ) , if < 0 ⇒ 0} & ( 8 a ) \\ \frac{{Q}_{i}}{{W}_{i , loc}} = \frac{{Q}_{i}}{{CDD}_{i , loc}} = \frac{{Q}_{i}}{{\sum }_{d = 1}^{{D}_{i}} ( {\overline{T}}_{i , loc} - 65 ) , if < 0 ⇒ 0} & ( 8 b )\end{matrix}$$

where, commonly, i=JAN, FEB, MAR, APR . . . and the values thus derived are then stored in a month-by-year matrix, and a running calculation of

$$E ( \frac{{Q}_{i}}{{W}_{i , loc}} )$$

over the past Y years is maintained. So, when module 401 calls for the historical data for billing period b,

$$E ( \frac{{Q}_{b}}{{W}_{b , loc}} )$$

is pulled from the Q/W data matrix and used to make the (over/under)-consumption determination, such determination may be achieved by executing the following calculation:

$$\begin{matrix}{Q}_{b} = E ( \frac{{Q}_{b}}{{W}_{b , loc}} ) \cdot {W}_{b , loc} & ( 9 ) \\ {Q}_{x , b} = {Q}_{b} - E ( {Q}_{b} ) & ( 10 )\end{matrix}$$

If the result of Equation (10) is positive and greater than the historical error εᵢ for that period, then decision module 420 sends process control over to module 425 where the detected excess usage is then queued for billing to a subsequent billing cycle. In other words, the utility bill UB_{b} for an immediately following billing period b+ would be

UB_{b+}=FB(Mᵢ)+P_{b}·Q_{x,b} (11)

where it can be seen that, for a monthly billing period b, the utility bill UB next month b+ will be the fixed bill FB that was calculated for that month b+ at module 130 (FIGS. 1 and 3) plus the total market price P·Q of the excess quantity Q_{x,b} of commodity consumed this month b. It may not be possible to charge the excess so soon, though, in which case the billing is deferred to a billing period b++ further in the future, or perhaps even issued in the form of a separate bill. This depends on how quickly the information needed can be assembled from the monitoring technology in place.

A provision in the contract for such an excess-use surcharge may be made more palatable by the introduction of a mirror provision that provides for a credit in the next consumption cycle whenever the utility consumer uses less than εᵢ less commodity per degree-day than calculated from the usage history. In this case control goes to module 440 where it is determined if the negative excess consumption (i.e., under-consumption, where Q_{x,b}<0) is more than εᵢ below the expectation value of consumption per unit weather indicator E(Q_{b}) for that billing period b. If so, the shortfall is credited to the utility consumer at the prevailing market price at module 445.

This feature solves two problems in the fixed bill art. First, how do you prevent runaway consumption when the utility consumer knows he need not pay more than the fixed bill for the contract term? The answer is, you bill him. Second, how do you derive meaningful “demand curve” data when you transition from the historical record in the database into the fixed bill era? This is the solution, namely that when the utility consumer goes out of bounds, one way or the other, the classic demand curve resumes where higher consumption costs more and lesser consumption costs less. The post-contract demand curve has a discontinuity in it within the 2εᵢ consumption bandwidth, but for those who go outside the consumption bandwidth frequently enough, the current active demand curve may be deduced.

The credits and surcharges, if any, would be expected to be received at the next billing period b at module 140 of FIG. 1. The current billing data for each billing period b (i.e., fix bill adjusted for surcharge or credit if any), current weather indicator data, and current consumption from nodes 425 and 445 may be written to the rolling historical database 720 on a rolling basis and will contribute to the next calculation of a fixed bill at the start of a new contract term or upon the detection of a consumption surge as indicated below. Hence the spike data allows monitoring of the demand curve.

### Consumption Surge

What will appear at first like a mere spike in consumption induced perhaps by a fixed payment may actually be a surge. That is, a long term structural increase in consumption of the utility commodity that may be caused by expansion of plant and equipment, increase in labor force of family size, expansion of the home, or even moving into a new home with differing requirements, and so forth.

Such a surge would present itself as a chronic billing period-to-billing period increase/decrease in consumption-per-unit-weather-indicator beyond the 2εᵢ consumption bandwidth provided for in the contract.

One way to detect a surge is to keep track of the spikes. This can be done by maintaining a Surge Count, which is a stored integer indicating the number of consecutive spikes. Hence, each time a spike, whether an overconsumption or underconsumption (negative surge), is detected and a bill adjusted, the Surge Count is incremented at 470 and returned as a return value by module 150. We can expect that a surge will result in a series of consecutive spikes, causing the surge count to steadily rise each billing period b. If, during such a rise, a break in the pattern is detected where there is no spike (|Q_{x,b}|≦εᵢ), then the Surge Count is decremented toward zero, but never below zero at 460.

Only a negative spike (Q_{x,b}<−εᵢ) can get the Surge Count negative by decrementing at node 480. Breaks in this “ebb” pattern results in the negative count being incremented toward zero, but never above zero at 460.

The reason for decrementing/incrementing the Surge Count toward zero instead of zeroing it out immediately when a spike is not detected is that there can be enough measurement error and weather variability that a particular surge value may well fall within a measured expectation value. Therefore, unless the spikes consistently fail to continue to appear, we may suspect a random anomaly.

When module 150 exits, the Surge Count is available to module 170 in FIG. 1 and it can be compared to a critical value determined by the user to arbitrarily define how many spikes in a row constitute a surge. This likely will depend on all sorts of factors unique to each business concern. Nevertheless, when the Surge Count is high enough (to break, or trigger a provision in, the contract, for example), control returns via the recalculation flowpath 180 to module 110 where the fixed bill FB(Mᵢ) is recalculated all over again using the new data, otherwise control goes back to module 150 via module 140 to continue to monitor the rates of consumption.

Note also in FIG. 1 that the actual consumptions Q_{b}, weather indicators W_{b}, and any spike data, meaning the surcharge or credit to be charged, may now be fed back to the rolling historical database 720 by way of flowpath 190 to pair up with and update the fixed bill FB(Mᵢ) figures that were fed back earlier at flowpath 160.

### Non-Weather Price Volatility

Finally, embedded in the deal pricing steps above, the commodity price volatility within the fixed bill may be managed. If only the expected value is purchased it is almost certain that there will be either too little or too much fixed price energy available for the utility consumer. A general rule that has been found to avoid this problem is for the provider to purchase forward, fixed price energy at from about zero to about one standard deviation below the expected consumption level for the utility consumer, and to purchase at-the-money calls on the next one to two or more standard deviations of consumption. It is found that this strategy covers up to 86% of the possible weather pattern events, with minimal but symmetric outliers beyond what is financially covered.

### System Architecture

In FIG. 7 there is shown an embodiment of an overall system architecture 700 that may be used to effectuate the processes of the disclosure. Central to the architecture is a computer 710 in communication with the rolling historical database 720. Before a customer is contracted as a utility consumer in the fixed bill program, historical consumption (Q) and prices paid (P) figures are recovered from what such data sources 730 are available. Historical weather indicator (W) sources 740 are also tapped for inclusion into the database 720. This information (Q,W,P) is then available to the computer 710 to solve Equation (4) and proceed with the derivation and output of fixed bills (P) 750 to all the utility consumers enrolled in the fixed bill program as has already been described. The pool of consumer payments and payoffs from swap receipts 760 may be recorded in the computer for accounting or, for turnkey operations, posting to Accounts Payable for payment to the utility provider.

The computer also reads in data on the current weather data (W) 770 and consumption data (Q) 780 by the individual utility consumers. After signing of the contracts K, these data become the newest (Q,W,P) data for inclusion into the rolling historical database 720. Each year that a utility consumer is enrolled in the fixed bill program, the oldest year Y data is deleted and the new (Q,W,P) data written in. Typically, this is done by having a pointer or handle to the oldest entry. The new data is written to the pointer, thereby overwriting the oldest data, and then the pointer is incremented to what has now become the oldest entry.

This is as described above with respect to FIG. 4, wherein a feature of this disclosure is the multiple feedback and continuous individual monitoring of all the utility consumers' consumption habits in order to detect spikes and surges. Further the unique spike detection feature disclosed herein, as stated earlier, maintains the value of the rolling historical database 720 as a reliable indicator of each utility consumer's consumption behavior far into the future after they have signed up for the fixed bill program.

As can be seen, a mechanism is presented that allows for the full risk management of a budget sensitive energy utility consumer. Energy utility consumers have heretofore been able to manage price risk but not overall cost risk. This is because the weather pattern has been previously unmanageable and there has been a lack of close monitoring of the utility consumer's consumption under fixed bill conditions. With a combination of price risk management and the ability to “lay off” weather risk to natural counterparties an energy provider can provide complete energy cost risk management.

The foregoing disclosures relate to illustrative embodiments of the invention and modifications may be made without departing from the spirit and scope of the invention as set forth in, and limited only by, the claims herein.

In the claims herein—unless explicitly indicated otherwise—the use of the word “or” is to be construed as the inclusive “or” in accordance with common usage in the engineering and computer arts.

What is claimed is:

1. A method of providing a fixed utility bill for a billing period to a utility consumer of a utility product, comprising the steps of:
maintaining in a rolling historical database, for each utility consumer, environmental indicator data and associated consumption of the utility product data;
calculating a continuous probability distributed current expectation value of a quantity of consumption for said utility consumer;
calculating a risk position in the form of a current fixed bill based upon said current expectation value; and
matching said risk position with a balancing fixed payment to a utility distribution company.

2. The method of claim 1 further comprising the steps of:
establishing a consumption bandwidth 2εᵢ of consumption of utility product per unit environmental indicator; and
billing a surcharge to the utility consumer should said utility consumer's consumption exceed said consumption bandwidth, or
posting a credit to the utility consumer should said utility consumer reduce consumption below the consumption bandwidth.

3. The method of claim 2 further comprising the step of:
writing the total billing, the quantity of consumption, and an environmental indicator for each billing period to said rolling historical database.

4. The method of claim 3 wherein said environmental indicator comprises an ambient weather indicator.

5. The method of claim 1 wherein said running risk position is further based on historical billings paid by said utility consumer.

6. The method of claim 5 wherein the step of calculating a continuous probability distributed current expectation value of a quantity of consumption for said utility consumer further comprises the step of performing a regression analysis of the equation:
Q_{i,loc}=α+βᵢW_{i,loc}+β₂P_{i-,loc}+εᵢ

7. The method of claim 6 further comprising the step of calculating said risk position of said utility consumer in the form of a fixed bill by the equation
$${EFB}_{i} = {F}_{i} + [ ( \frac{1}{( 1 - {M}_{i} )} {C}_{i} + {T}_{i} + {LD}_{i} ) \cdot ( α + {β}_{1} E ( {W}_{loc} ) + {β}_{2} {P}_{i} ) ]$$
where Mᵢ is derived from Monte Carlo simulations.

8. The method of claim 1 wherein said matching of said risk position further comprises an expectation value payoff to said utility distribution company by means of a hedge position in environmental indicator derivatives.

9. The method of claim 8 wherein said environmental indicator derivatives comprise weather indicator derivatives.

10. A turnkey provider process to provide a utility provider with the ability to provide fixed utility bills to utility consumers of a utility product, comprising the steps of:
said turnkey provider:
receiving from said utility provider a list of participating utility consumers;
maintaining in a rolling historical database, for each utility consumer, environmental indicator data and associated consumption of the utility product data;
calculating a continuous probability distributed current expectation value of a quantity of consumption for each said utility consumer;
calculating a risk position in the form of a current fixed bill based upon said current expectation value for each said utility consumer; and
receiving payments on said fixed bills from each said utility consumers;
matching said risk position with a balancing fixed retained fee from each said received payment and retained proceeds from environmental indicator hedge positions; and
distributing the remainder of each said payments and proceeds from environmental hedge positions to the utility distribution company as a fixed payment amount.

11. The turnkey provider process of claim 10 further comprising the steps of:
establishing a consumption bandwidth 2εᵢ of consumption of utility product per unit environmental indicator for each said utility consumer; and
billing a surcharge to the utility consumer should said utility consumer's consumption exceed said consumption bandwidth, or
posting a credit to the utility consumer should said utility consumer reduce consumption below the consumption bandwidth.

12. The turnkey provider process of claim 11 further comprising the step of:
writing the total billing, the quantity of consumption, and an environmental indicator for each billing period to said rolling historical database.

13. The turnkey provider process of claim 12 wherein said environmental indicator comprises an ambient weather indicator.

14. The turnkey provider process of claim 10 wherein said running risk position is further based on historical billings paid by said utility consumer.

15. The turnkey provider process of claim 14 wherein the step of calculating a continuous probability distributed current expectation value of a quantity of consumption for said utility consumer further comprises the step of performing a regression analysis of the equation:
Q_{i,loc}=α+βᵢW_{i,loc}+β₂P_{i-,loc}+εᵢ

16. The turnkey provider process of claim 15 further comprising the step of calculating said risk position of said utility consumer in the form of a fixed bill by the equation
$${EFB}_{i} = {F}_{i} + [ ( \frac{1}{( 1 - {M}_{i} )} {C}_{i} + {T}_{i} + {LD}_{i} ) \cdot ( α + {β}_{1} E ( {W}_{loc} ) + {β}_{2} {P}_{i} ) ]$$
where Mᵢ is derived from Monte Carlo simulations.

17. The turnkey provider process of claim 10 wherein said matching of said risk position further comprises an expectation value payoff to said utility distribution company by means of a hedge position in environmental indicator derivatives.

18. The turnkey provider process of claim 17 wherein said environmental indicator derivatives comprise weather indicator derivatives.

19. A system architecture for providing fixed billing process, comprising:
a computer;
a rolling historical database in communication with said computer, said database configured to receive and hold historical and current consumption, billing, and weather indicator data on a rolling basis over the past Y years for at least one utility consumer; and
said computer programmed to:
receive current weather indicator data;
issue fixed utility bills to each said utility consumer;
monitor each said consumer's consumption of a utility product and adjust current billing, as needed, of said utility consumer with a surcharge or credit upon said consumer's consumption falling outside a pre-calculated bandwidth; and
write said current consumption, current billing, and current weather indicator data to said rolling historical database.
